(19) United States
(12) Patent Application Publication
(10) Pub. No.: US 2026/0296652 A1
(43) Pub. Date: Oct. 1, 2026

(54) AERO-CONFORMING ICE DETECTOR

(71) Applicant: Raytheon Company, Arlington, VA (US)

(72) Inventors: Kevin H. Rowse, TUCSON, AZ (US); Timothy V. Seppanen, TUCSON, AZ (US); Aubrey A. Vann, TUCSON, AZ (US); Christian Kessler, TUCSON, AZ (US)

(21) Appl. No.: 19/092,629

(22) Filed: Mar. 27, 2025

(51) Int. Cl. B64D 15/22; G01V 9/00

(52) U.S. Cl. CPC B64D 15/22; G01V 9/005

(57) ABSTRACT

An ice sensor having a frame, a comb, and a wire is provided. The frame has first and second arms and a rack extending between the arms. The comb has first and second sets of teeth. Teeth of the first set define a first channel and teeth of the second set define a second channel. The teeth of the sets have a first length and a second length longer than the first length. The first set defines a first cavity between each tooth of the first set having the second length and the rack surface. The second set defines a second cavity between each tooth of the second set having the second length and the rack surface. The wire extends between the first channel and the second channel and is in the first and second cavities such that the wire has a serpentine configuration.

### GOVERNMENT LICENSE RIGHTS

The subject matter disclosed herein was made with government support under contract number withheld awarded by the United States Department of Defense. The government has certain rights in the invention.

### TECHNICAL FIELD

Examples relate to ice sensors and more specifically to ice sensors for aeronautical applications.

### BACKGROUND

In the field of aerospace technology, detecting ice formation on flight surfaces is important for maintaining safety and performance. Traditional ice detection systems often extend from the fuselage and protrude into airflow over the flight surface. The protrusion can disrupt the aerodynamic profile of sleek missile designs. Moreover, traditional systems typically require significant power. The significant power consumption makes these systems unsuitable for power-limited applications such as unmanned aerial vehicles (UAVs) and other autonomous flying platforms.

Existing low profile ice detection systems also face challenges in terms of reliability and ease of integration. Many of these systems are not easily replaceable or adaptable to various aircraft configurations, thereby limiting their utility across different platforms. Furthermore, the complexity and power requirements of these systems can lead to increased maintenance and operational costs.

### BRIEF DESCRIPTION OF DRAWINGS

FIG. 1 illustrates an aircraft on which examples described herein may be used.

FIG. 2 shows an ice sensor that may be used with the aircraft of FIG. 1.

FIGS. 3A and 3B are top views of a rack of the ice sensor of FIG. 2.

FIG. 4 illustrates a serpentine configuration of a wire shown in FIGS. 2 and 3A.

FIG. 5 shows the wire of FIG. 4 wound around a rack of the ice sensor of FIGS. 2, 3A, and 3B

FIG. 6 shows the formation of a cavity by teeth of the ice sensor shown in FIGS. 2, 3A, and 3B.

FIG. 7 illustrates an inlet formed in the aircraft of FIG. 1 that receives the ice sensor of FIG. 2.

FIG. 8 shows the ice sensor of FIG. 2 disposed within the inlet of FIG. 7.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Examples relate to an ice sensor that can be used for various aeronautic applications. The ice sensor can include a frame having a rack at a distal end of the frame. The frame can include a comb having teeth of first and second lengths. The first length can be shorter than the second length. In addition, the teeth having the second length can define a cavity between the teeth and the rack.

A first set of the teeth can be disposed on a first side of the rack. A second set of the teeth can be disposed on a second side of the rack opposite the first side. The teeth can have the first and second lengths on each side of the rack. Furthermore, the teeth can define channels within which a wire can be disposed.

The wire can loop between the teeth in a serpentine fashion about the rack. The wire can also loop around the teeth having the second length by tracking through the cavities defined by the teeth having the second length. The wire can be used to ultimately determine the temperature of a fluid passing over the ice sensor by measuring the voltage. More specifically, the wire can be exposed at a leading edge of the rack and the ice sensor between the first set of teeth and the second of teeth. The ice sensor can also include a heating element thermally coupled with the rack. The heating element can function to heat the rack during operation of the ice sensor.

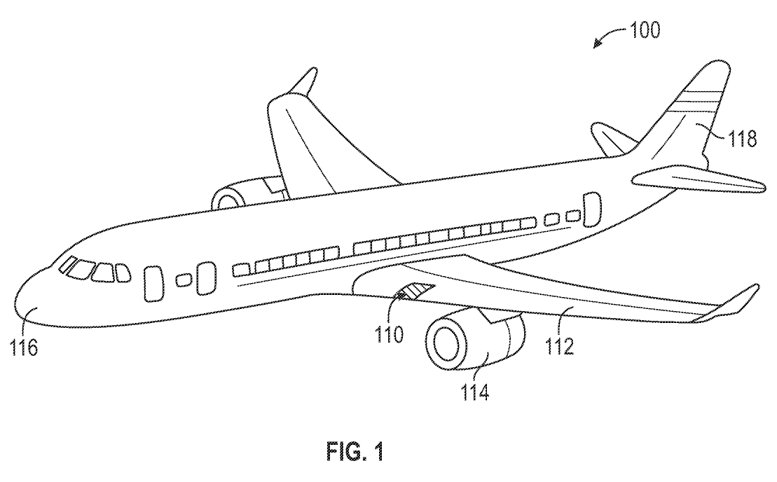

Now referring to FIG. 1, an aircraft 100 is shown in which an ice sensor 110 can be disposed and used. While an aircraft is shown in which the ice sensor 110 can be disposed and used, examples are not limited to the aircraft 100 and instead the ice sensor 110 can be used in any type of application, such as, but not limited to, any type of flight capable craft, such as a missile, spacecraft, and other vehicular applications, such as automotive applications, marine applications, or the like. Furthermore, while the ice sensor 110 is shown as being disposed in a wing 112 of the aircraft 100, the ice sensor 110 can be disposed at any portion of the aircraft 100 having a surface exposed to airflow about the aircraft 100. Therefore, the ice sensor 110 can be disposed in a cowling of an engine 114, a nose portion 116 of the aircraft 100, or a tail 118 of the aircraft 100.

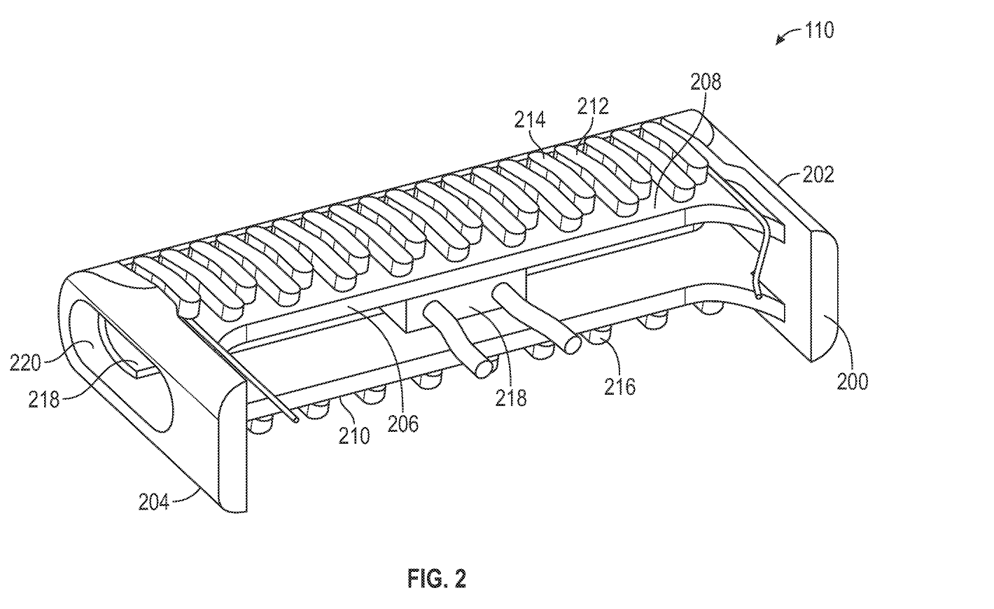

The ice sensor 110 can include a frame 200 having an arm 202 and an arm 204 opposite the frame arm 202, as shown with reference to FIG. 2. A rack 206 can extend between the frame arms 202 and 204. The rack 206 can include external surfaces 208 and 210 about which a comb defined by teeth 212-216 can be disposed. The teeth 212 and 214 can be disposed on the rack surface 208 and the teeth 216 can be disposed on the rack surface 210.

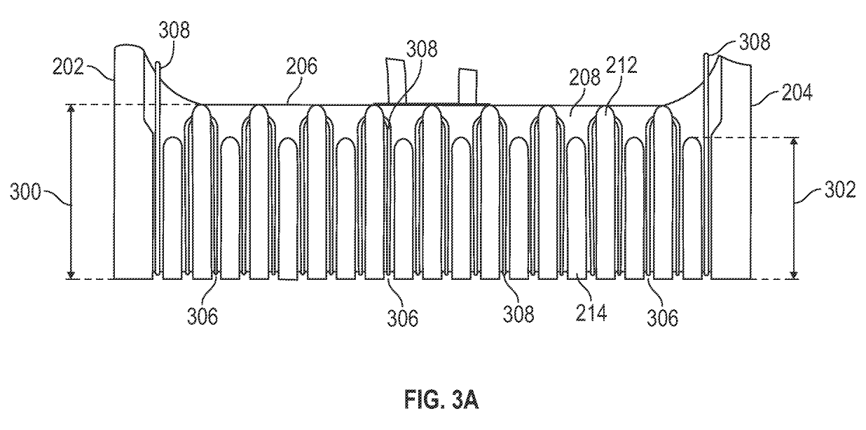

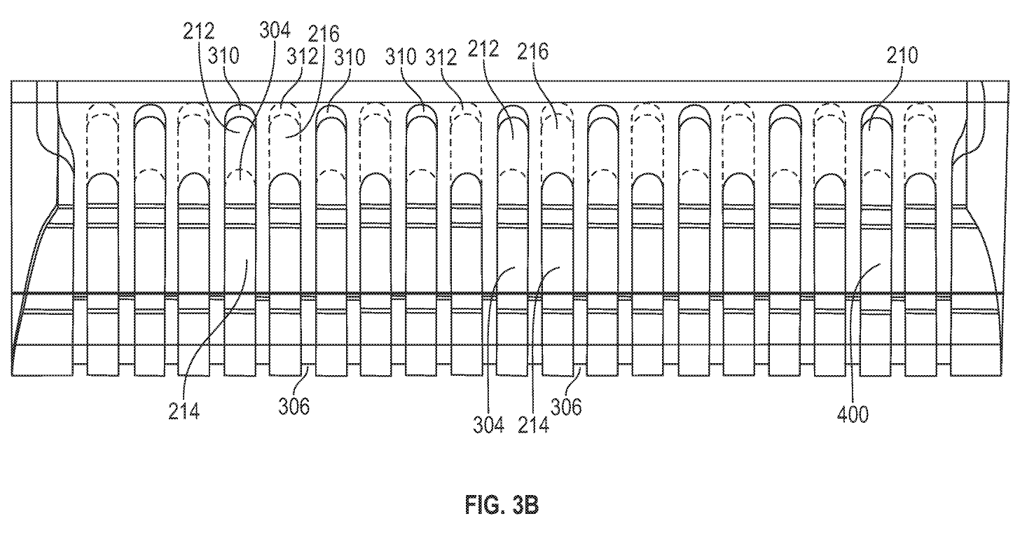

Now making reference to FIGS. 3A and 3B, a top view of the rack 206 is shown. The teeth 212 can have a length 300 that is greater than a length 302 of the teeth 214. The teeth 212 and 214 can form an alternating pattern on the rack surface 208 where one of the teeth 212 alternates with one of the teeth 214 on the rack surface 208. The lengths 300 and 302 can define the alternating pattern in addition to the positioning of the teeth 212 next to the teeth 214. While an alternating pattern of the teeth 212 and 214 is shown, examples envision the teeth 212 and 214 having any pattern on the rack 206.

In addition to the teeth 216, the rack surface 210 can include teeth 304. The teeth 216 can have the length 300 and the teeth 304 can have the length 302. The teeth 216 and 304 can form an alternating pattern on the rack surface 210 where one of the teeth 216 alternates with one of the teeth 304 on the rack surface 210. The lengths 300 and 302 can define the alternating pattern in addition to the positioning of the teeth 216 next to the teeth 304. Moreover, the alternating pattern of the teeth 216 and 304 can be offset from the alternating pattern of the teeth 212 and 214. In particular, the teeth 216 can align with the teeth 214. Furthermore, the teeth 212 can align with the teeth 304. While an alternating pattern of the teeth 216 and 304 is shown, examples envision the teeth 216 and 304 having any pattern on the rack 206. The alternating pattern can permit a continuous path for the wire or a conductor. In examples, a conductive medium can be arranged when a length of the conductive medium can provide a defined resistance end to end of the conductive medium along with an even exposure to the environment.

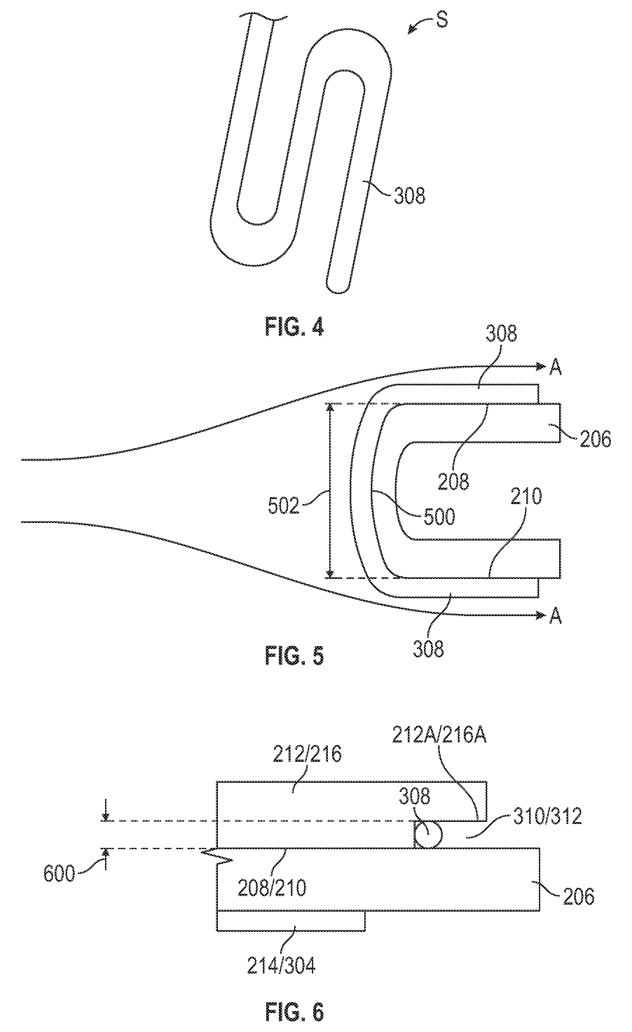

In combination, individual ones of the teeth 212 and 214 can form channels 306 on the rack surface 208. Similarly, in combination, individual ones of the teeth 216 and 304 can form channels that mirror the channels 306 on the rack surface 210. A wire 308 can extend through the channels 306 and the channels formed by the combination of the teeth 216 and 304. The wire 308 can extend through channels of the teeth 212-216 and 304 and around the teeth 212-216 and 304 as shown with reference to FIG. 3A to form a serpentine configuration S as shown with reference to FIGS. 4 and 5.

In order to form the serpentine configuration S, the wire 308 can loop around the teeth 212 on the rack surface 208 and loop around the teeth 216 on the rack surface 210. In order to facilitate looping of the wire 308, the teeth 212 can define a cavity 310. In a similar fashion, the teeth 216 can define a cavity 312 in order to facilitate looping of the wire 308, as shown with reference to FIG. 6. A surface 212A/216A of the teeth 212/216 can extend a distance 600 from the rack surface 208/210 to form the cavities 310/312. When the wire 308 loops around the teeth 212/216, the wire 308 can rest in the cavities 310/312.

By looping around the teeth 212-216 and 304 and around the rack 206, a surface area of the wire 308 can be exposed at a leading edge 500 (FIG. 5) of the rack 206. The leading edge 500 can face oncoming airflow A that flows about the aircraft 100. The leading edge 500 can have a height or width 502 where the wire 308 can extend across the leading-edge width 502. By virtue of extending across the leading-edge width 502 and into the airflow A, the wire 308 can be exposed to the airflow A. The wire 308 can extend around all of the teeth 212-216 and 304 and, as a result, wrap around the leading edge 500 as shown with reference to FIG. 5 multiple times. Since the wire 308 can wrap around the leading edge 500 multiple times, a surface area of the wire 308 exposed to the airflow A can be maximized, thereby increasing an accuracy with which a thermal mass in the airflow A can be determined.

The wire 308 can be a sense wire and can be configured to determine a thermal mass of a fluid in the airflow A. The fluid can be water and can be in gaseous, liquid, or solid form. The wire 308 can be formed from a metal such as Platinum, Nickel, Tungsten, Copper, or the like where the electrical resistance of the metal changes with temperature. More specifically, a current can be sent through the wire 308, which will cause the wire to rise in temperature at a rate proportional to the difference in electrical energy supplied and thermal energy removed from the fluid passing over the wire. In instances when the fluid passing over the wire 308 is water, greater thermal energy is removed than when the fluid is air, thereby decreasing the rate at which the wire increases in temperature. The change in the rate of temperature increase can correlate to the change from air to water. While the wire 308 is described as being composed of a metal, the wire can be any material selected based on a fluid being measured in the airflow A and capable of having a temperature dependent electrical resistance. In addition, while the fluid is described as being water in one of gaseous, liquid, or solid forms, the fluid can be anything capable of flowing in the airflow A where the sensor can be used to measure characteristics of the fluid.

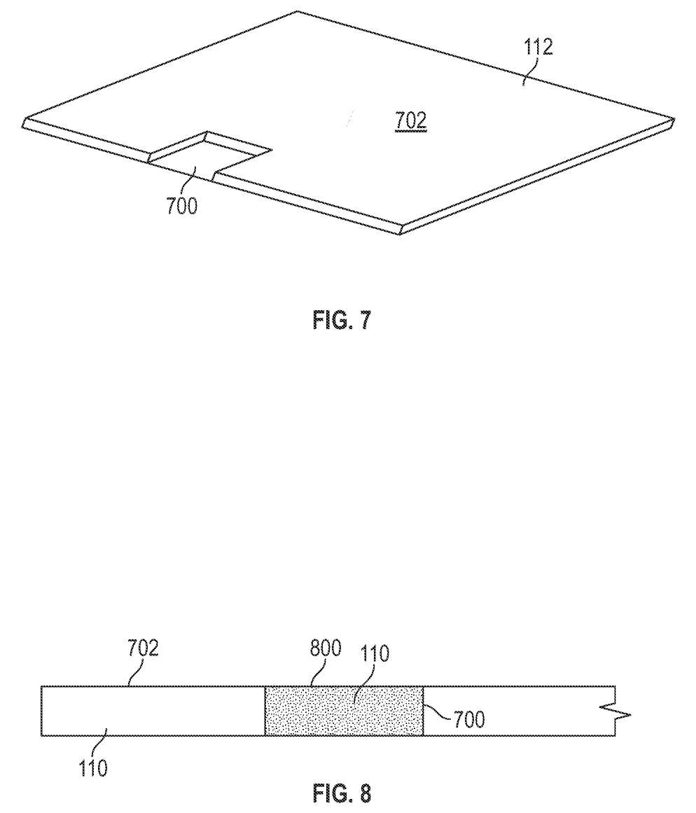

In examples, the aircraft 100 can have an inlet 700 in a surface 702 that is exposed to the airflow A, as shown with reference to FIG. 7. The inlet 700 can be configured to receive the ice sensor 110. The ice sensor 110 can include a top surface 800, which as can be seen with reference to FIG. 8, can be flush with the surface 702. Since the ice sensor top surface 800 is flush with the surface 702, the ice sensor 110 does not interfere with the air flow A about the aircraft 100. In examples where the ice sensor 110 is disposed at another location of a craft, such as the engine 114, the nose portion 116, or the tail 118, each of the engine 114, the nose portion 116, or the tail 118 can have an inlet similar to the inlet 700 where the ice sensor 110 is disposed within the inlet. Furthermore, the ice sensor top surface 800 can be flush with a surface about which the air flow A traverses around one of the engine 114, the nose portion 116, or the tail 118 such that the ice sensor 110 does not interfere with the air flow A about the aircraft 100.

Returning attention to FIG. 2, the ice sensor 110 can also include a heating element 218 at the rack 206. The heating element 218 can be at an inner surface 220 of the rack 206 and thermally coupled with the rack 206. The heating element 218 can function to maintain a temperature of the rack 206 above a temperature of a fluid being monitored by the ice sensor 110 becomes a solid, such as the freezing point of water. The heating element 218 can be activated once a determination is made that an ambient temperature in which the aircraft 100 is operating is at, or lower than, the temperature at which a monitored fluid becomes a solid. The heating element 218 can be a Kapton heating element or any other type of heating element capable of keeping the rack 206 above a certain temperature, such as the freezing temperature of water or a temperature at which a fluid being monitored by the ice sensor 110 becomes a solid.

The frame 200, the rack 206, and the teeth 212-216 and 304 can be formed from the same material as a single, unitary piece. The frame 200, the rack 206, and the teeth 212-216 and 304 can be formed from a metal, such as aluminum, stainless steel, or the like. In addition, the frame 200, the rack 206, and the teeth 212-216 and 304 can be formed from a polymer where the frame 200, the rack 206, and the teeth 212-216 and 304 are formed with an injection molding process.

In examples where the frame 200, the rack 206, and the teeth 212-216 and 304 are formed from metal, the frame 200, the rack 206, and the teeth 212-216 and 304 can be anodized after formation and prior to the wire 308 being provided to the ice sensor 110. Moreover, the frame 200, the rack 206, and the teeth 212-216 and 304 can be subjected to an electro-polishing process prior to the wire 308 being provided to the ice sensor 110. The frame 200, the rack 206, and the teeth 212-216 and 304 can be anodized in order to electrically isolate the wire 308 from the frame 200, the rack 206, and the teeth 212-216 and 304. The frame 200, the rack 206, and the teeth 212-216 and 304 can be electro-polished in order to remove any surface, which can damage the wire 308.

### Additional Examples

Example 1 is an ice sensor for a flight capable craft, the ice sensor comprising: a frame having: a first arm and a second arm; and a rack extending between the first arm and the second arm; a comb disposed about a first surface of the rack and a second surface of the rack, the comb including: a first set of teeth on the rack first surface where individual ones of the first set of teeth define a first channel; and a second set of teeth on the rack second surface where individual ones of the second set of teeth define a second channel, wherein: teeth of the first set of teeth and teeth of the second set of teeth have a first length and a second length longer than the first length; the first set of teeth define a first cavity between each tooth of the first set of teeth having the second length and the rack first surface; and the second set of teeth define a second cavity between each tooth of the second set of teeth having the second length and the rack second surface; and a wire extending between each of the first channel and the second channel, the wire being disposed in each of the first cavity and the second cavity such that the wire has a serpentine configuration about the rack.

In Example 2, the subject matter of Example 1 includes, wherein the ice sensor further comprises a heating element at the rack, the heating element being configured to heat the rack.

In Example 3, the subject matter of Examples 1–2 includes, wherein each of the first set of teeth having the second length have a first surface that extends a distance away from the rack first surface where the first cavity is defined between first teeth surface and the rack first surface.

In Example 4, the subject matter of Examples 1–3 includes, wherein each of the second set of teeth having the second length have a second surface that extends a distance away from the rack second surface where the second cavity is defined between second teeth surface and the rack second surface.

In Example 5, the subject matter of Examples 1–4 includes, wherein the first set of teeth form a first alternating pattern where the teeth of the first set of teeth having the first length alternate with the teeth of the first set of teeth having the second length.

In Example 6, the subject matter of Example 5 includes, wherein: the second set of teeth form a second alternating pattern where the teeth of the second set of teeth having the first length alternate with the teeth of the second set of teeth having the second length; and the first alternating pattern is offset the second alternating pattern such that the teeth of the first set of teeth having the first length align with the teeth of the second set of teeth having the second length and the teeth of the first set of teeth having the second length align with the teeth of the second set of teeth having the first length.

In Example 7, the subject matter of Example 6 includes, wherein the rack has a leading edge and the wire has a first surface exposed at the rack leading edge such that the wire first surface is exposed to airflow about the flight capable craft.

In Example 8, the subject matter of Examples 1–7 includes, wherein the ice sensor is configured to be disposed within an inlet of the flight capable craft to be flush with a surface of the flight capable craft within which the flight capable craft inlet is disposed.

Example 9 is an ice sensor for a flight capable craft, the ice sensor comprising: a frame having: a first arm and a second arm; and a rack extending between the first arm and the second arm; a comb disposed about a first surface of the rack and a second surface of the rack, the comb including: a first set of teeth on the rack first surface; and a second set of teeth on the rack second surface, wherein: teeth of the first set of teeth and teeth of the second set of teeth have a first length and a second length longer than the first length; the first set of teeth define a first cavity between each tooth of the first set of teeth having the second length and the rack first surface; and the second set of teeth define a second cavity between each tooth of the second set of teeth having the second length and the rack second surface; and a wire extending between each of the first set of teeth and the second set of teeth, the wire being disposed in each of the first cavity and the second cavity such that the wire has a serpentine configuration about the rack.

In Example 10, the subject matter of Example 9 includes, wherein: individual ones of the first set of teeth define a first channel; individual ones of the second set of teeth define a second channel; and the wire extending between each of the first channel and the second channel.

In Example 11, the subject matter of Example 10 includes, wherein each of the first set of teeth having the second length have a first surface that extends a distance away from the rack first surface where the first cavity is defined between first teeth surface and the rack first surface.

In Example 12, the subject matter of Examples 10–11 includes, wherein each of the second set of teeth having the second length have a second surface that extends a distance away from the rack second surface where the second cavity is defined between second teeth surface and the rack second surface.

In Example 13, the subject matter of Examples 10–12 includes, wherein: the first set of teeth form a first alternating pattern where the teeth of the first set of teeth having the first length alternate with the teeth of the first set of teeth having the second length; the second set of teeth form a second alternating pattern where the teeth of the second set of teeth having the first length alternate with the teeth of the second set of teeth having the second length; the first alternating pattern is offset the second alternating pattern such that the teeth of the first set of teeth having the first length align with the teeth of the second set of teeth having the second length and the teeth of the first set of teeth having the second length align with the teeth of the second set of teeth having the first length; and the rack has a leading edge and the wire has a first surface exposed at the rack leading edge such that the wire first surface is exposed to airflow about the flight capable craft.

In Example 14, the subject matter of Examples 10–13 includes, wherein the ice sensor is configured to be disposed within an inlet of the flight capable craft to be flush with a surface of the flight capable craft within which the flight capable craft inlet is disposed.

In Example 15, the subject matter of Examples 9–14 includes, wherein the ice sensor further comprises a heating element at the rack, the heating element being configured to heat the rack.

Example 16 is an ice sensor for a flight capable craft, the ice sensor comprising: a frame having: a first arm and a second arm; and a rack extending between the first arm and the second arm; a comb disposed about a first surface of the rack and a second surface of the rack, the comb including: a first set of teeth on the rack first surface; and a second set of teeth on the rack second surface, wherein: teeth of the first set of teeth and teeth of the second set of teeth have a first length and a second length longer than the first length; the first set of teeth define a first cavity between each tooth of the first set of teeth having the second length and the rack first surface; the second set of teeth define a second cavity between each tooth of the second set of teeth having the second length and the rack second surface; the first set of teeth form a first alternating pattern where the teeth of the first set of teeth having the first length alternate with the teeth of the first set of teeth having the second length; and the second set of teeth form a second alternating pattern where the teeth of the second set of teeth having the first length alternate with the teeth of the second set of teeth having the second length; a wire extending between each of the first set of teeth and the second set of teeth, the wire being disposed in each of the first cavity and the second cavity such that the wire has a serpentine configuration about the rack.

In Example 17, the subject matter of Example 16 includes, wherein: each of the first set of teeth having the second length have a first surface that extends a distance away from the rack first surface where the first cavity is defined between first teeth surface and the rack first surface; and each of the second set of teeth having the second length have a second surface that extends a distance away from the rack second surface where the second cavity is defined between second teeth surface and the rack second surface.

In Example 18, the subject matter of Examples 16–17 includes, wherein: the first alternating pattern is offset the second alternating pattern such that the teeth of the first set of teeth having the first length align with the teeth of the second set of teeth having the second length and the teeth of the first set of teeth having the second length align with the teeth of the second set of teeth having the first length; and the rack has a leading edge and the wire has a first surface exposed at the rack leading edge such that the wire first surface is exposed to airflow about the flight capable craft.

In Example 19, the subject matter of Examples 16–18 includes, wherein: individual ones of the first set of teeth define a first channel; individual ones of the second set of teeth define a second channel; and the wire extending between each of the first channel and the second channel.

In Example 20, the subject matter of Examples 16–19 includes, wherein the ice sensor is configured to be disposed within an inlet of the flight capable craft to be flush with a surface of the flight capable craft within which the flight capable craft inlet is disposed.

Example 21 is an apparatus comprising means to implement of any of Examples 1–20.

Example 22 is a method to implement of any of Examples 1–21.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. An ice sensor for a flight capable craft, the ice sensor comprising:
a frame having:
a first arm and a second arm; and
a rack extending between the first arm and the second arm;
a comb disposed about a first surface of the rack and a second surface of the rack, the comb including:
a first set of teeth on the rack first surface where individual ones of the first set of teeth define a first channel; and
a second set of teeth on the rack second surface where individual ones of the second set of teeth define a second channel, wherein:
teeth of the first set of teeth and teeth of the second set of teeth have a first length and a second length longer than the first length;
the first set of teeth define a first cavity between each tooth of the first set of teeth having the second length and the rack first surface; and
the second set of teeth define a second cavity between each tooth of the second set of teeth having the second length and the rack second surface; and
a wire extending between each of the first channel and the second channel, the wire being disposed in each of the first cavity and the second cavity such that the wire has a serpentine configuration about the rack.

2. The ice sensor of claim 1, wherein the ice sensor further comprises a heating element at the rack, the heating element being configured to heat the rack.

3. The ice sensor of claim 1, wherein each of the first set of teeth having the second length have a first surface that extends a distance away from the rack first surface where the first cavity is defined between first teeth surface and the rack first surface.

4. The ice sensor of claim 1, wherein each of the second set of teeth having the second length have a second surface that extends a distance away from the rack second surface where the second cavity is defined between second teeth surface and the rack second surface.

5. The ice sensor of claim 1, wherein the first set of teeth form a first alternating pattern where the teeth of the first set of teeth having the first length alternate with the teeth of the first set of teeth having the second length.

6. The ice sensor of claim 5, wherein:
the second set of teeth form a second alternating pattern where the teeth of the second set of teeth having the first length alternate with the teeth of the second set of teeth having the second length; and
the first alternating pattern is offset the second alternating pattern such that the teeth of the first set of teeth having the first length align with the teeth of the second set of teeth having the second length and the teeth of the first set of teeth having the second length align with the teeth of the second set of teeth having the first length.

7. The ice sensor of claim 6, wherein the rack has a leading edge and the wire has a first surface exposed at the rack leading edge such that the wire first surface is exposed to airflow about the flight capable craft.

8. The ice sensor of claim 1, wherein the ice sensor is configured to be disposed within an inlet of the flight capable craft to be flush with a surface of the flight capable craft within which the flight capable craft inlet is disposed.

9. An ice sensor for a flight capable craft, the ice sensor comprising:
a frame having:
a first arm and a second arm; and
a rack extending between the first arm and the second arm;
a comb disposed about a first surface of the rack and a second surface of the rack, the comb including:
a first set of teeth on the rack first surface; and
a second set of teeth on the rack second surface, wherein:
teeth of the first set of teeth and teeth of the second set of teeth have a first length and a second length longer than the first length;
the first set of teeth define a first cavity between each tooth of the first set of teeth having the second length and the rack first surface; and
the second set of teeth define a second cavity between each tooth of the second set of teeth having the second length and the rack second surface; and
a wire extending between each of the first set of teeth and the second set of teeth, the wire being disposed in each of the first cavity and the second cavity such that the wire has a serpentine configuration about the rack.

10. The ice sensor of claim 9, wherein:
individual ones of the first set of teeth define a first channel;
individual ones of the second set of teeth define a second channel; and
the wire extending between each of the first channel and the second channel.

11. The ice sensor of claim 10, wherein each of the first set of teeth having the second length have a first surface that extends a distance away from the rack first surface where the first cavity is defined between first teeth surface and the rack first surface.

12. The ice sensor of claim 10, wherein each of the second set of teeth having the second length have a second surface that extends a distance away from the rack second surface where the second cavity is defined between second teeth surface and the rack second surface.

13. The ice sensor of claim 10, wherein:
the first set of teeth form a first alternating pattern where the teeth of the first set of teeth having the first length alternate with the teeth of the first set of teeth having the second length;
the second set of teeth form a second alternating pattern where the teeth of the second set of teeth having the first length alternate with the teeth of the second set of teeth having the second length;
the first alternating pattern is offset the second alternating pattern such that the teeth of the first set of teeth having the first length align with the teeth of the second set of teeth having the second length and the teeth of the first set of teeth having the second length align with the teeth of the second set of teeth having the first length; and
the rack has a leading edge and the wire has a first surface exposed at the rack leading edge such that the wire first surface is exposed to airflow about the flight capable craft.

14. The ice sensor of claim 10, wherein the ice sensor is configured to be disposed within an inlet of the flight capable craft to be flush with a surface of the flight capable craft within which the flight capable craft inlet is disposed.

15. The ice sensor of claim 9, wherein the ice sensor further comprises a heating element at the rack, the heating element being configured to heat the rack.

16. An ice sensor for a flight capable craft, the ice sensor comprising:
a frame having:
a first arm and a second arm; and
a rack extending between the first arm and the second arm;
a comb disposed about a first surface of the rack and a second surface of the rack, the comb including:
a first set of teeth on the rack first surface; and
a second set of teeth on the rack second surface, wherein:
teeth of the first set of teeth and teeth of the second set of teeth have a first length and a second length longer than the first length;
the first set of teeth define a first cavity between each tooth of the first set of teeth having the second length and the rack first surface;
the second set of teeth define a second cavity between each tooth of the second set of teeth having the second length and the rack second surface;
the first set of teeth form a first alternating pattern where the teeth of the first set of teeth having the first length alternate with the teeth of the first set of teeth having the second length; and
the second set of teeth form a second alternating pattern where the teeth of the second set of teeth having the first length alternate with the teeth of the second set of teeth having the second length;
a wire extending between each of the first set of teeth and the second set of teeth, the wire being disposed in each of the first cavity and the second cavity such that the wire has a serpentine configuration about the rack.

17. The ice sensor of claim 16, wherein:
each of the first set of teeth having the second length have a first surface that extends a distance away from the rack first surface where the first cavity is defined between first teeth surface and the rack first surface; and
each of the second set of teeth having the second length have a second surface that extends a distance away from the rack second surface where the second cavity is defined between second teeth surface and the rack second surface.

18. The ice sensor of claim 16, wherein:
the first alternating pattern is offset the second alternating pattern such that the teeth of the first set of teeth having the first length align with the teeth of the second set of teeth having the second length and the teeth of the first set of teeth having the second length align with the teeth of the second set of teeth having the first length; and
the rack has a leading edge and the wire has a first surface exposed at the rack leading edge such that the wire first surface is exposed to airflow about the flight capable craft.

19. The ice sensor of claim 16, wherein:
individual ones of the first set of teeth define a first channel;
individual ones of the second set of teeth define a second channel; and
the wire extending between each of the first channel and the second channel.

20. The ice sensor of claim 16, wherein the ice sensor is configured to be disposed within an inlet of the flight capable craft to be flush with a surface of the flight capable craft within which the flight capable craft inlet is disposed.
